(19) United States
(12) Patent Application Publication
(10) Pub. No.: US 2026/0017927 A1
(43) Pub. Date: Jan. 15, 2026

(54) IMAGE LOCALISATION

(71) Applicant: Commonwealth Scientific and Industrial Research Organisation, Acton (AU)

(72) Inventors: Shan WANG, Acton (AU); Chuong NGUYEN, Acton (AU)

(21) Appl. No.: 19/211,088

(22) Filed: May 16, 2025

(30) Foreign Application Priority Data
Jul. 9, 2024 (AU) 2024902115

(51) Int. Cl. G06V 10/771; G06V 10/44; G06V 20/17

(52) U.S. Cl. CPC G06V 10/771; G06V 10/44; G06V 20/17

(57) ABSTRACT

A method for localising a ground-based query image captured by an imaging device with respect to an aerial image of a physical environment within which the imaging device is disposed, enabling a pose of the imaging device to be determined within the physical environment. The method includes obtaining query features identified in the ground-based query image, identifying elevated features from the query features, generating aggregated pixels by aggregating elevated pixels of the elevated features onto a ground plane of the ground-based query image and generating a query feature map using the aggregated pixels, wherein the query feature map is usable in localising the ground-based query image by mapping the query feature map to an aerial feature map of aerial features within the aerial image.

### RELATED APPLICATION

This application claims the benefit of and priority to Australian Patent Application No. 2024902115, filed on Jul. 9, 2024, the entirety of the disclosure of which is hereby incorporated by this reference.

### BACKGROUND

The present disclosure relates to a method and system for image localisation enabling a pose of an imaging device to be determined within a physical environment, and in one particular example, a method and system for localising a ground-based query image captured by the imaging device with respect to an aerial image of the physical environment within which the imaging device is disposed.

### DESCRIPTION OF THE PRIOR ART

The reference in this specification to any prior publication (or information derived from it), or to any matter which is known, is not, and should not be taken as an acknowledgement or admission or any form of suggestion that the prior publication (or information derived from it) or known matter forms part of the common general knowledge in the field of endeavour to which this specification relates.

In general, visual-based cross-view localization aims to localise query images taken from street-level or ground-based cameras within an aerial image, such as satellite or aerial view map. Platforms like the Google Map API have made satellite images accessible, spurring the development of cross-view localization techniques. Despite this, accurate localization remains challenging due to the significant viewpoint differences between ground-based and aerial images. These viewpoint differences result in a domain gap, adversely impacting feature alignment, thereby compromising the overall accuracy of localization.

Prior research has explored two main approaches to bridge the domain gap in image-based localization: generative-based and geometry-alignment-based methods. Generative-based methods, such as those utilizing GANs, as discussed for example in Xiaoyang Tian, Jie Shao, Deqiang Ouyang, and Heng Tao Shen, “UAV-satellite view synthesis for cross-view geo-localization”, IEEE Transactions on Circuits and Systems for Video Technology, 32 (7): 4804-4815, 2021 (“[21]”), and diffusion models, as discussed for example in Zelong Zeng, Zheng Wang, Fan Yang, and Shin'ichi Satoh., “Geo-localization via ground-to-satellite cross-view image retrieval”, IEEE Transactions on Multimedia, 25:2176-2188, 2023 (“[31]”), reduce the domain gap by transforming view styles from one view to another. However, the generated features for matching can lead to ambiguities in pose estimation.

In contrast, geometry-alignment-based methods, employing techniques like polar transformations, as discussed for example in Yujiao Shi, Xin Yu, Dylan Campbell, and Hongdong Li, “Where am I looking at? joint location and orientation estimation by cross-view matching”, Proceedings of the IEEE/CVF Conference on Computer Vision and Pattern Recognition, pages 4064-4072, 2020 (“[17]”), and Aysim Toker, Qunjie Zhou, Maxim Maximov, and Laura Leal-Taixé, “Coming down to earth: Satellite-to-street view synthesis for geo-localization”, Proceedings of the IEEE/CVF Conference on Computer Vision and Pattern Recognition, pages 6488-6497, 2021 (“[22]”), or homography, as discussed for example in Yujiao Shi and Hongdong Li, “Beyond cross-view image retrieval: Highly accurate vehicle localization using satellite image”, Proceedings of the IEEE Conference on Computer Vision and Pattern Recognition, 2022 (“[16]”), Shan Wang, Chuong Nguyen, Jiawei Liu, Kaihao Zhang, Wenhan Luo, Yanhao Zhang, Sundaram Muthu, Fahira Afzal Maken, and Hongdong Li, “Homography guided temporal fusion for road line and marking segmentation” Proceedings of the IEEE/CVF International Conference on Computer Vision, pages 1075-1085, 2023 (“[25]”) and Xiaolong Wang, Runsen Xu, Zuofan Cui, Zeyu Wan, and Yu Zhang, “Fine-grained cross-view geo-localization using a correlation-aware homography estimator”, arXiv preprint arXiv: 2308.16906, 2023 (“[28]”), focus on establishing correspondences for on-ground pixels. This often results in the neglect of off-ground features, such as streetlights, and difficulty in handling visual occlusions, such as the obscuring of road details by treetops in aerial views. This neglect fails to leverage important geographic landmarks on the road and results in a lack of robustness to issues like road mark degradation (e.g. fading and damaged paintings).

Early visual-only cross-view localization methods, as discussed for example in Sixing Hu, Mengdan Feng, Rang M H Nguyen, and Gim Hee Lee, “Cvm-net: Cross-view matching network for image-based ground-to-aerial geo-localization”, Proceedings of the IEEE Conference on Computer Vision and Pattern Recognition, pages 7258-7267, 2018 (“[8]”), Liu Liu and Hongdong Li. Lending orientation to neural networks for cross-view geo-localization”, The IEEE Conference on Computer Vision and Pattern Recognition (CVPR), 2019 (“[11]”), [17], Yujiao Shi, Xin Yu, Liu Liu, Tong Zhang, and Hongdong Li, “Optimal feature transport for cross-view image geo-localization”, Proceedings of the AAAI Conference on Artificial Intelligence, pages 11990-11997, 2020 (“[18]”), [22] and Sijie Zhu, Taojiannan Yang, and Chen Chen Vigor, “Cross-view image geo-localization beyond one-to-one retrieval”, Proceedings of the IEEE/CVF Conference on Computer Vision and Pattern Recognition, pages 3640-3649, 2021 (“[32]”), approach the task as an image retrieval problem, focusing on coarse localization through image-to-image matching. To bridge the domain gap between ground and aerial views, various techniques have been proposed to facilitate cross-view feature matching. [11] incorporated per-pixel orientation information, while [17] and [22] utilized a predefined polar transform to align aerial-view images with ground views. Additionally, [21] and [31] employed GAN-based and diffusion model-based style transformations, respectively. While efforts have been made to minimize the domain gap, these methods rely on image-level feature matching, restricting their localization accuracy, often falling short of the precision achieved by commercial GPS systems in open areas, as discussed for example in Frank Van Diggelen and Per Enge, “The world's first gps mooc and worldwide laboratory using smartphones”, Proceedings of the 28th international technical meeting of the satellite division of the institute of navigation (ION GNSS+2015), pages 361-369, 2015 (“[23]”).

To improve accuracy, several methods employ patch-wise feature matching, especially effective in aerial views with wide fields of view and high resolutions. For instance, Sijie Zhu, Mubarak Shah, and Chen Chen, “Transgeo: Transformer is all you need for cross-view image geo-localization”, Proceedings of the IEEE/CVF Conference on Computer Vision and Pattern Recognition, pages 1162-1171, 2022 (“[33]”) employs transformers to emphasize informative patches, Zimin Xia, Olaf Booij, Marco Manfredi, and Julian F P Kooij, “Visual cross-view metric localization with dense uncertainty estimates”, Computer Vision-ECCV 2022: 17th European Conference, Tel Aviv, Israel, Oct. 23-27, 2022, Proceedings, Part XXXIX, pages 90-106. Springer, 2022 (“[29]”) and Zimin Xia, Olaf Booij, and Julian F P Kooij, “Convolutional cross-view pose estimation”, arXiv preprint arXiv: 2303.05915, 2023 (“[30]”) compute dense spatial distributions using patch attention, and Ted Lentsch, Zimin Xia, Holger Caesar, and Julian F P Kooij, “Slicematch: Geometry-guided aggregation for cross-view pose estimation”, Proceedings of the IEEE/CVF Conference on Computer Vision and Pattern Recognition, pages 17225-17234, 2023 (“[10]”) introduces the ‘slice-to-sector match’ and ‘Cross-view attention’ to calculate similarity between aerial sectors and ground view slices. However, their attention queries are derived from aerial images, posing reliability issues when the pose is unknown. OrienterNet per Paul-Edouard Sarlin, Daniel DeTone, Tsun-Yi Yang, Armen Avetisyan, Julian Straub, Tomasz Malisiewicz, Samuel Rota Bulo, Richard Newcombe, Peter Kontschieder, and Vasileios Balntas, “OrienterNet: Visual Localization in 2D Public Maps with Neural Matching”, CVPR, 2023 (“[15]”) transforms ground view images into Bird's Eye View (BEV) grids for matching with OpenStreetMap data. Despite these advancements, localization accuracy remains limited by the patch (grid) size.

Pixel-wise feature matching has been explored in various methods, as discussed for example in Florian Fervers, Sebastian Bullinger, Christoph Bodensteiner, Michael Arens, and Rainer Stiefelhagen, “Uncertainty-aware vision-based metric cross-view geolocalization”, Proceedings of the IEEE/CVF Conference on Computer Vision and Pattern Recognition, pages 21621-21631, 2023 (“[4]”) and [16], for precise localization, yet they struggle with the inherent domain gap between views. Geometry-alignment-based methods, such as in [16], prioritize on-ground pixel correspondences but overlook off-ground features and occlusions, leading to suboptimal performance. CVGL per [4] transforms the ground view image into a BEV for aerial matching. The BEV transformation employs aerial coordinates as queries, introducing a high degree of freedom and increasing the complexity of matching. In the BoostAcc framework, per Yujiao Shi, Fei Wu, Akhil Perincherry, Ankit Vora, and Hongdong Li, “Boosting 3-dof ground-to-satellite camera localization accuracy via geometry-guided cross-view transformer, 2023 (“[19]”), homography transformation is used on ground views to source query pixel data for the pixel-to-slice attention mechanism. This transformation introduces distortions from non-ground pixels, potentially exacerbating errors in subsequent processing stages. Moreover, the keys and values span entire and adjacent columns, risking compounded ambiguities in both longitudinal and lateral estimation.

### SUMMARY

In one broad form, the present disclosure relates to a method for localising a ground-based query image captured by an imaging device with respect to an aerial image of a physical environment within which the imaging device is disposed, enabling a pose of the imaging device to be determined within the physical environment. The method includes, in one or more processing devices: obtaining query features identified in the ground-based query image; identifying elevated features from the query features; generating aggregated pixels by aggregating elevated pixels of the elevated features onto a ground plane of the ground-based query image; and generating a query feature map using the aggregated pixels, wherein the query feature map is usable in localising the ground-based query image by mapping the query feature map to an aerial feature map of aerial features within the aerial image.

The method may include, in the one or more processing devices, for each elevated feature: identifying corresponding ground pixels directly beneath the elevated pixels; and, aggregating elevated and corresponding ground pixels.

The method may include, in the one or more processing devices, aggregating pixels of elevated features with the ground pixels using an attention mechanism. The method may further include, in the one or more processing devices, generating by the attention mechanism, an attention feature map by: determining a value and key from the elevated pixels; generating a query using pixel data of the corresponding ground pixels; applying a non-linear mapping to map the query and key to a common feature space; and, computing a matrix product of the query and key; and, generating a feature vector for the ground pixels using the matrix product and the value to generate the attention feature map including the feature vectors as the aggregated pixels. The method may still further include, in the one or more processing devices, vertically stacking the attention feature map with a ground plane query feature map to generate an aggregated feature map representing the query feature map.

The method may include, in the one or more processing devices, mapping the query feature map to the aerial feature map by detecting query keypoints in the query feature map and mapping the query keypoints to matching aerial keypoints in the aerial feature map. Detecting the query keypoints and aerial keypoints may include: generating a view-consistent confidence map representing a confidence of a feature appearing in both the query feature map and the aerial feature map; and generating a ground-plane confidence map representing a confidence of query features of the query feature map being on the ground-plane; and detecting the query keypoints based on the view-consistent confidence map and the ground-plane confidence map.

The method may be performed, in the one or more processing devices, using at least one computational model.

The at least one computational model may have at least one parameter adjusted to adapt for a domain variation between the ground-based query image and the aerial image towards mapping the query feature map to the aerial feature map. The at least one parameter may be adjusted to adapt for domain variation to account for a variance in focal length associated with the ground-based query image and the aerial image.

The at least one computational model may be trained to explicitly enforce view-invariant query and aerial feature maps based on L2 loss functions in three feature spaces to determine a query feature representation loss, an aerial feature representation loss and a latent feature representation loss. The query feature representation loss may be based on an average of the squared difference between ground truth aerial keypoints of the aerial feature map, projected to and from a latent feature space guided by focal length, and matched query keypoints. The aerial feature representation loss may be based on an average of the squared difference between query keypoints, projected to and from the latent feature space guided by focal length, and matched ground truth aerial keypoints. The latent feature representation loss may be based on an average of the squared difference between query keypoints, projected to the latent feature space guided by focal length, and ground truth aerial keypoints, projected to the latent feature space guided by focal length.

The at least one computational model may have at least one parameter adjusted to adapt for a perspective variation between the ground-based query image and the aerial image towards mapping the query feature map to the aerial feature map. The at least one parameter may be adjusted to adapt for perspective variation to account for a variance between a mapped query keypoint and a matching ground truth aerial keypoint as a function of a distance between the matching ground truth aerial keypoint and a ground truth pose of the imaging device within the aerial feature map.

In a further broad form, the present disclosure relates to a system for localising a ground-based query image captured by an imaging device with respect to an aerial image of a physical environment within which the imaging device is disposed, enabling a pose of the imaging device to be determined within the physical environment. The system includes one or more processing devices configured to: obtain query features identified in the ground-based query image; identify elevated features from the query features; generate aggregated pixels by aggregating elevated pixels of elevated features onto a ground plane of the query image; and generate a query feature map using the aggregated pixels, wherein the query feature map is usable in localising the ground-based query image by mapping the query feature map to an aerial feature map of aerial features within the aerial image.

In a further broad form, the present disclosure relates to a non-transitory computer-readable medium comprising computer-executable instructions that when executed perform the method of: obtaining query features identified in the ground-based query image; identifying elevated features from the query features; generating aggregated pixels by aggregating elevated pixels of the elevated features onto a ground plane of the ground-based query image; and generating a query feature map using the aggregated pixels, wherein the query feature map is usable in localising the ground-based query image by mapping the query feature map to an aerial feature map of aerial features within the aerial image.

It will be appreciated that the broad forms of the disclosure and their respective features can be used in conjunction and/or independently, and reference to separate broad forms is not intended to be limiting. Furthermore, it will be appreciated that features of the method can be performed using the system.

### BRIEF DESCRIPTION OF THE DRAWINGS

Various examples and embodiments of the present disclosure will now be described with reference to the accompanying drawings, in which:—

FIG. 1 is a flow chart of an example of a method for localising a ground-based query image captured by an imaging device with respect to an aerial image of a physical environment within which the imaging device is disposed;

FIG. 2 is a schematic diagram of an example of a system for localising a ground-based query image captured by an imaging device with respect to an aerial image of a physical environment within which the imaging device is disposed;

FIGS. 3A and 3B are a flow chart of a further example of a method for localising a ground-based query image captured by an imaging device with respect to an aerial image of a physical environment within which the imaging device is disposed;

FIG. 4 is an image depicting example spatial embedded ground-based query and aerial images;

FIG. 5 is a schematic diagram of an example architecture of a computational model for performing the method of FIGS. 3A and 3B;

FIG. 6 is an image depicting a difference in appearance of objects in accordance with perspectives of an example ground-based query image and an example aerial image;

FIG. 7 is an image depicting an example attenuation mechanism with respect to a ground-based query image;

FIG. 8 is an image illustrating examples of comparative confidence maps in relation to a ground-based query image;

FIG. 9 show an image illustrating examples of comparative keypoints in relation to a ground-based query image;

FIG. 10 a further schematic diagram of the example architecture of FIG. 5;

FIG. 11 is a table of comparative results between a method performed in accordance with an example embodiment of the present disclosure and further methods for image localisation;

FIG. 12 is a further table of comparative results between a method performed in accordance with an example embodiment of the present disclosure and further methods for image localisation;

FIG. 13 is a selection of charts showing comparative results under varying noise ranges between a method performed in accordance with an example embodiment of the present disclosure with and without employing top-to-ground aggregation, Cycle Domain Adaptation loss and Equidistant Re-Projection loss;

FIGS. 14 and 15 is a table of comparative results and associated graphs illustrating pose estimation by a method performed in accordance with an example embodiment of the present disclosure and further methods for image localisation established on a KITTI-CVL dataset;

FIGS. 16 and 17 is a selection of graphs illustrating pose estimation by a method performed in accordance with an example embodiment of the present disclosure and further methods for image localisation established on a Ford-CVL dataset;

FIG. 18 is a graph and associated image illustrating results of a method performed in accordance with an example embodiment of the present disclosure under sudden illumination shifts;

FIG. 19 is a selection of graphs illustrating results of a method performed in accordance with an example embodiment of the present disclosure under varying processing frequencies;

FIG. 20 is a table of comparative results between a method performed in accordance with an example embodiment of the present disclosure with and without employing each of top-to-ground aggregation, Cycle Domain Adaptation loss and Equidistant Re-Projection loss;

FIG. 21 is a selection of images depicting example daytime ground-based query images and their night-time analogs; and

FIG. 22 is a table of comparative results between a method performed in accordance with an example embodiment of the present disclosure and further methods for image localisation on a KITTI Day-to-Night Dataset.

### DETAILED DESCRIPTION

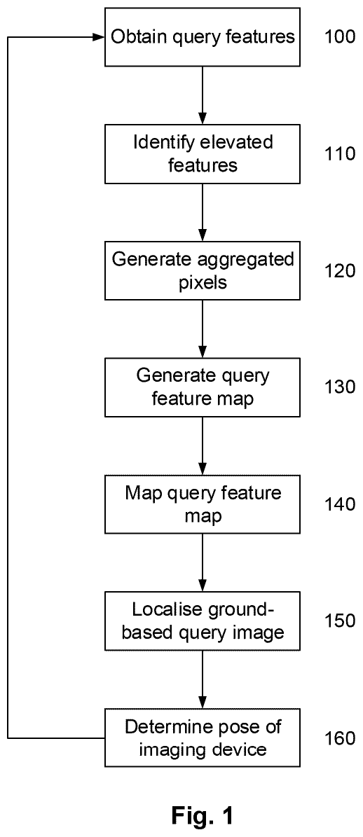

An example of a method for localising a ground-based query image captured by an imaging device with respect to an aerial image of a physical environment within which the imaging device is disposed, thereby enabling a pose of the imaging device to be determined within the physical environment, will now be described with reference to FIG. 1.

The physical environment can be structured or unstructured, and could be a natural, urban and/or rural environment, including an open environment or confined environment.

An on-ground query image in the present context therewith typically refers to an image captured by an imaging device that is on the ground or proximate to the ground in the physical environment relative to an aerial image. In this regard, non-limiting examples of an aerial image are satellite images and drone images, whether orthogonal to a view angle of the on-ground query image or otherwise as will become apparent from the description herein.

Accordingly, and for the purpose of the present example, the imaging device is assumed to be any imaging device, such as a vehicle with a mounted camera or cameras, hand-held camera or cameras or the like, capable of capturing an on-ground query image or images, traversing or having traversed the physical environment. The vehicle could include non-autonomous or autonomous vehicles, robots, or the like. The vehicle could use a range of different locomotion mechanisms depending on the physical environment, and could include wheels, tracks, or legs. Accordingly, it will be appreciated that the term image device used in the present context should be interpreted broadly and should not be construed as being limited to any particular type of vehicle-mounted camera.

Therewith, the camera of the imaging device will typically be in wired or wireless communication with one or more electronic processing devices configured to receive signals from the camera and either process the signals, or provide these to a processing device remote from the imaging device for processing and analysis in accordance with the present disclosure. In one specific example, this involves one or more processing devices implementing at least one computational model to perform the localisation of the ground-based query image captured by the imaging device with respect to an aerial image of a physical environment within which the imaging device is disposed.

The one or more processing devices could be of any suitable form and could include a microprocessor, microchip processor, logic gate configuration, firmware optionally associated with implementing logic such as an FPGA (Field Programmable Gate Array), or any other electronic device, system or arrangement. This process can be performed using multiple processing devices, with processing being distributed between one or more of the devices as needed, so for example some processing could be performed onboard the imaging device, with other processing being performed remotely. Nevertheless, for the purpose of ease of illustration, the following examples will refer to a single processing device, but it will be appreciated that reference to a singular processing device should be understood to encompass multiple processing devices and vice versa, with processing being distributed between the devices as appropriate.

The method involves the processing device obtaining query features identified in the ground-based query image at step 100. This is typically performed using some form of image processing technique. In one specific example, the query features are in the form of a feature map, such as a “ground-view” feature map, established from the ground-based query image by a spatially aware feature extractor. It will be appreciated by those skilled in the art that query features could be identified by any suitable image processing technique for identifying or extracting features within an image as will become clear to those skilled in the art from the present disclosure.

At step 110, the processing device identifies elevated features from the query features. In the context of an urban or rural environment, the elevated features may be associated with landmarks of the physical environment that are elevated from the ground or “off-ground”, such as tall structures, street lights, trees or the like. Query features are therewith typically features identified by a computational model from a two dimensional representation of a part of the physical environment captured in the ground-based query image.

At step 120, the processing device aggregates pixels by aggregating elevated pixels of the elevated features onto a ground plane of the ground-based query image. Various pixel aggregation techniques known in general for resampling may be suitable towards this particular aggregation of elevated pixels, including but not limited to feedforward neural networks by example multilayer perceptron (MLP) such as conventionally applied in image classification. In one non-limiting example, aggregation can be performed using a Transformer based on an attention mechanism as described in Ashish Vaswani, Noam Shazeer, Niki Parmar, Jakob Uszkoreit, Llion Jones, Aidan N Gomez, Łukasz Kaiser, and Illia Polosukhin, “Attention is all you need”, Advances in neural information processing systems, 30, 2017 (“[24]”). The aggregated pixels in such an example may therewith correspond to on-ground or ground-plane pixels of an attention feature map associated with the ground-based query image and that includes feature vectors as a function of an aggregation of on-ground pixels and corresponding elevated pixels identified directly beneath them. An example of this is described in more detail below. However, it will be appreciated by those skilled in the art that other aggregation techniques could also be used. Irrespective of the aggregation technique, the application of the aggregation to elevated pixels is distinct to traditional approaches.

At step 130, the processing device generates a query feature map using the aggregated pixels. In accordance with the above example, the query feature map can be generated by vertically stacking the attention feature map and a ground plane query feature map. The ground plane query feature map in this example therewith include query features associated with the ground plane in the ground-based query image. The resulting query feature map is therewith usable in localising the ground-based query image by mapping the query feature map to an aerial feature map of aerial features within the aerial image as at step 140.

In one particular example, mapping the query feature map to an aerial feature map is performed by generating confidence maps corresponding to the query feature map and aerial feature map respectively, and using a fusion of the confidence maps to detect two dimensional keypoints matched between the ground-based query image and the aerial image. In this example, mapping the query feature map to the aerial feature map may be performed by mapping the two dimensional keypoints associated with the ground-based query image to their matching two dimensional keypoints in the aerial image based on a ground-plane homography-based mechanism.

Accordingly, by generating a query feature map that is usable in localising the ground-based query image, the method enables a pose of the imaging device to be determined as at step 160, at least in part leveraging elevated or off-ground feature information to improve feature, in accordance with an example as keypoints, mapping or alignment between the ground-based query image and the aerial image, so as to account, by example, for visual occlusions in the aerial image.

A number of further features will now be described.

In one example, for each elevated feature the processing device identifies corresponding ground pixels directly beneath the elevated pixels and aggregates elevated and corresponding ground pixels. Aggregating the pixels in this manner ensures attributes of the elevated feature are combined with corresponding ground pixels. This allows for improved matching of elevated features with aerial features, whilst maintaining alignment between ground and elevated features, so that the ground plane can serve for homographic alignment with the aerial features.

In one example the processing device aggregates pixels of elevated features with the ground pixels using an attention mechanism. Using an attention mechanism in this manner can provide an important cue to alleviate a representation gap between query features and aerial features within the aerial image.

In one example the processing device generates by the attention mechanism, an attention feature map by: determining a value and key from the elevated pixels; generating a query using pixel data of the corresponding ground pixels; applying a non-linear mapping to map the query and key to a common feature space; computing a matrix product of the query and key; and, generating a feature vector for the ground pixels using the matrix product and the value to generate the attention feature map including the feature vectors as the aggregated pixels. Generating the attention feature map in this manner can enable an accurate reflection on the connection between the ground pixels and their corresponding elevated pixels.

In one example the processing device vertically stacks the attention feature map with a ground plane query feature map to generate an aggregated feature map representing the query feature map. An aggregated feature map generated in this manner provides an advantage in subsequent estimation of a pose of the imaging device by further alleviating feature discrepancy between ground-based and aerial images.

In one example the processing device maps the query feature map to the aerial feature map by detecting query keypoints in the query feature map and mapping the query keypoints to matching aerial keypoints in the aerial feature map. Mapping keypoints in this manner can enable a distribution of features being mapped across the query feature map and therewith improve the accuracy of any subsequent pose determination.

In one example the processing device detects the query keypoints and aerial keypoints by: generating a view-consistent confidence map representing a confidence of a feature appearing in both the query feature map and the aerial feature map; and generating a ground-plane confidence map representing a confidence of query features of the query feature map being on the ground-plane; and detecting the query keypoints based on the view-consistent confidence map and the ground-plane confidence map. Using confidence maps in this manner can enhance temporal stability and view consistency and therewith improve the accuracy of any subsequent pose determination.

In one example the method is performed in the processing device using at least one computational model. It will be appreciated that this can not only facilitate performance of the method but can also allow the computational model to be configured towards adjusting to account for the ambiguity of purely image-based localisation.

In this regard and in one example, the computational model has at least one parameter adjusted to adapt for a domain variation between the ground-based query image and the aerial image towards mapping the query feature map to the aerial feature map. Adjustment in this manner can allow for taking into account varying appearances of the same feature or object across different views, camera specifications, e.g. tone, hue, intensity, brightness and resolution, and temporal changes of varying spans that lead to inconsistent representations of the same physical environment or part thereof. Therewith, in one example the at least one parameter is adjusted to adapt for domain variation to account for a variance in focal length associated with the ground-based query image and the aerial image.

In one specific example where at least one parameter is adjusted to adapt for a domain variation, the computational model is trained to explicitly enforce view-invariant query and aerial feature maps based on L2 loss functions in three feature spaces to determine a query feature representation loss, an aerial feature representation loss and a latent feature representation loss.

In one example and towards facilitating the explicit enforcement of view-invariant representations, the query feature representation loss is based on an average of the squared difference between ground truth aerial keypoints of the aerial feature map, projected to and from a latent feature space guided by focal length, and matched query keypoints; the aerial feature representation loss is based on an average of the squared difference between query keypoints, projected to and from the latent feature space guided by focal length, and matched ground truth aerial keypoints; and the latent feature representation loss is based on an average of the squared difference between query keypoints, projected to the latent feature space guided by focal length, and ground truth aerial keypoints, projected to the latent feature space guided by focal length.

In one example, the computational model has at least one parameter adjusted to adapt for a perspective variation between the ground-based query image and the aerial image towards mapping the query feature map to the aerial feature map. Adjustment in this manner can at least partially prevent forcing keypoint detection closer to the imaging device by preventing the scaling of an orientation error.

In this regard and in one specific example, the at least one parameter is adjusted to adapt for perspective variation to account for a variance between a mapped query keypoint and a matching ground truth aerial keypoint as a function of a distance between the matching ground truth aerial keypoint and a ground truth pose of the imaging device within the aerial feature map.

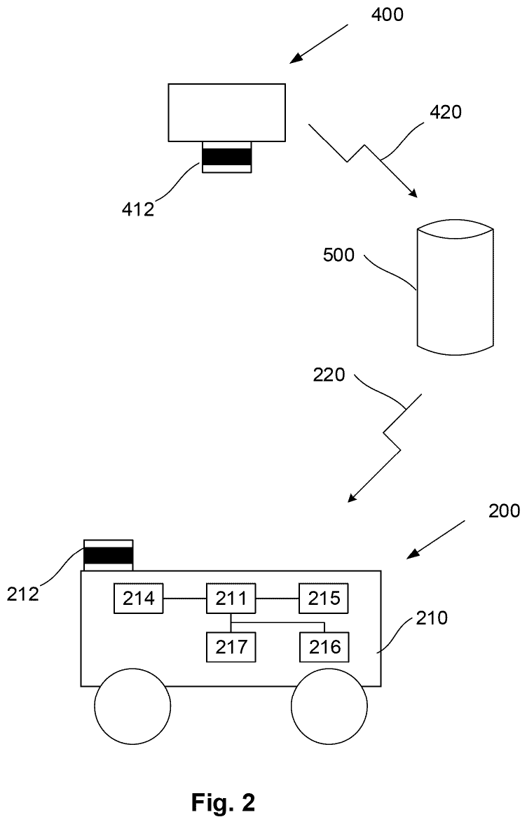

A non-limiting example of a system for localising a ground-based query image captured by an imaging device with respect to an aerial image of a physical environment within which the imaging device is disposed is shown in FIG. 2, with the imaging device generally designated by reference numeral 200.

In this example, the imaging device 200 includes one or more cameras 212 located on a vehicle 210. It will be appreciated that disclosure is not limited in the location or manner in which the one or more cameras 212 are located on the vehicle 210, so long as the one or more cameras are located so as to be able to capture ground-based query images, such as towards the front, back and/or sides of the vehicle 210. The imaging device 200 has at least one electronic processing device 211 located on-board, which is in wired or wireless connection with the one or more cameras 212 so as to receive signals including the ground-based query images from the camera. The processing device 211 may also be coupled to a control system 214 to allow movement of the vehicle to be controlled, and one or more other sensors 215. This could include proximity sensors, such as for additional safety control.

The processing device 211 can also be connected to an external interface 216, such a wireless interface, to allow wireless communications with a remote processing device, such as via a mobile communications network, 4G or 5G network, WiFi network, or via direct point-to-point connections, such as Bluetooth, or the like.

The electronic processing device 211 is also coupled to a memory 217, which stores applications software executable by the processing device 211 to allow methods to be performed including methods in accordance with the present disclosure. The applications software may include one or more software modules, and may be executed in a suitable execution environment, such as an operating system environment, or the like. The memory 217 may also be configured to allow ground-based query images to be stored as required, as well as to store any data generated during the performance of the methods. It will be appreciated that the memory could include volatile memory, non-volatile memory, or a combination thereof, as needed.

FIG. 2 further shows an aerial imaging device 400. The aerial imaging device 400 may be any static or moving aerial or “off-ground” device that is capable of capturing an aerial image or aerial images of the physical environment in which the imaging device 200 is disposed. By non-limiting example, such an aerial imaging device 400 includes a satellite or satellites and non-autonomous or autonomous aircraft, such as a drone, that includes one or more cameras 412 located thereon.

In the above context, it will be appreciated that the at least one electronic processing device 211 and/or the remote processing device(s) to which the processing device 211 is connected can be in direct or indirect data communication with the aerial imaging device 400 so as to receive an aerial image captured thereby for use in a method in accordance with the present disclosure. In one example, aerial images captured by a camera 412 of the aerial imaging device 400 may be received 420 at and stored in a database 500, local to or remote from the imaging device 200, that is accessible by the at least one electronic processing device 211 and/or the remote processing device(s) so that the aerial images are capable of being retrieved 220 and used by the at least one electronic processing device 211 and/or the remote processing device(s). In one non-limiting example, the database 500 may be a Google Earth, or other similar, database accessible via the mobile communications network, 4G or 5G network, or WiFi network by means of an Application Programming Interface (API) so as to be able to retrieve Google, or other, satellite imagery as aerial images.

It will be appreciated that the above described system configuration assumed for the purpose of the following examples is not essential, and numerous other system configurations may be used. For example, although the vehicle is shown as a wheeled vehicle in this instance, it will be appreciated that this is not essential, and a wide variety of vehicles and locomotion systems could be used.

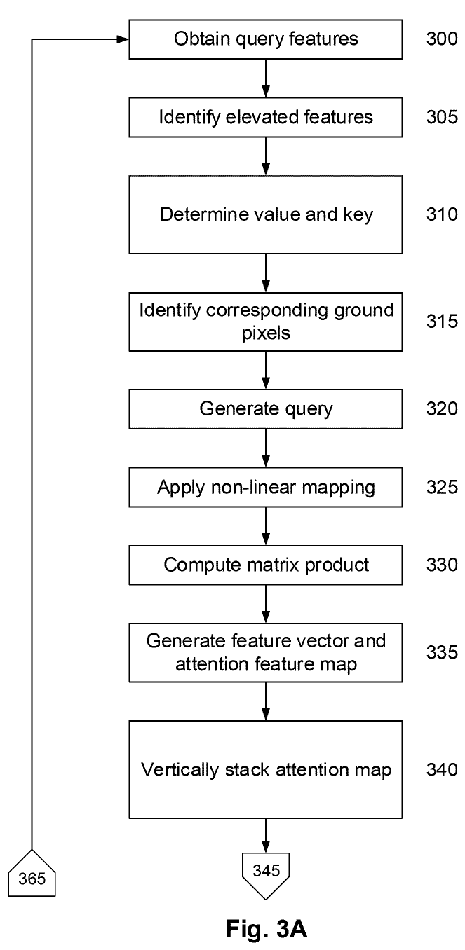

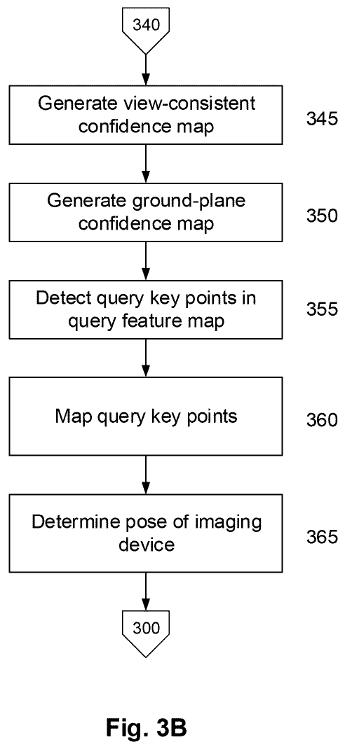

A further example of a method for localising a ground-based query image captured by an imaging device with respect to an aerial image of a physical environment within which the imaging device is disposed will now be described in greater detail with reference to FIGS. 3A and 3B.

In this example, the method is performed by a computational model, such as a computational model including a trained convolutional neural network, such as a U-Net or other similar structure, to extract query features from the ground-based query image and aerial features from the aerial image, as a geo-referenced aerial image. It will be appreciated other suitable computational models could alternatively be used. Therewith and at step 300, the extracted query features are obtained by the processing device and elevated features are identified from the extracted query features at step 305.

Next, pixels are aggregated using an attention mechanism to generate an attention feature map including the aggregated pixels. For example, the attention mechanism can be based on the attention mechanism described above with reference to [24]. In this regard and at step 310, a value and key is determined by the processing device from the elevated pixels. At step 315, the processing device identifies corresponding ground pixels directly beneath the elevated pixels and generates a query using pixel data of the corresponding ground pixels at step 320. Next, at step 325, the processing device applies a non-linear mapping to map the query and key to a common feature space, ensuring that the query and key are mapped to the same feature space before the processing device computes a matrix product of the query and key at step 330. At step 335, the processing device generates a feature vector for the ground pixels using the matrix product and the value to generate the attention feature map including the feature vectors as the aggregated pixels. At step 340, the processing device vertically stacks the attention feature map with a ground plane query feature map to generate an aggregated feature map representing the query feature map.

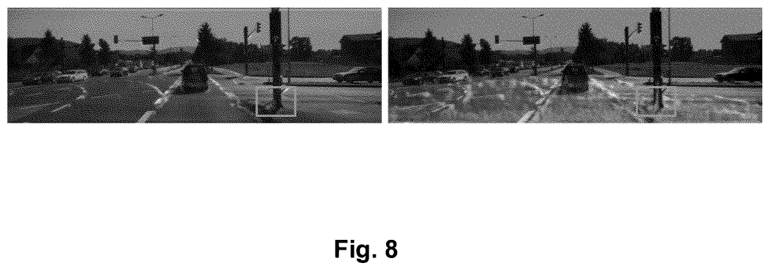

Thereafter, the processing device maps the query feature map to the aerial feature map by detecting query keypoints in the query feature map and mapping the query keypoints to matching aerial keypoints of the aerial feature map. In this regard and at step 345, the processing device generates a view-consistent confidence map representing a confidence of a feature appearing as both a query feature in the query feature map and an aerial feature in the aerial feature map. At step 350, the processing device generates a ground-plane confidence map representing a confidence of query features of the query feature map being on the ground-plane. It will be appreciated that step 345 and 350 may be performed in any sequence or simultaneously, provided that at step 355 the processing device detects the query keypoints based on the view-consistent confidence map and the ground-plane confidence map. In one example, the processing device detects the query keypoints based on a fusion of the view-consistent confidence map and the ground-plane confidence map, as shown in the right-hand side of FIG. 8 and further discussed herein below. According to this example, the view-consistent and on-ground maps are combined to create a single “fused” confidence map which is used to detect two dimensional query keypoints.

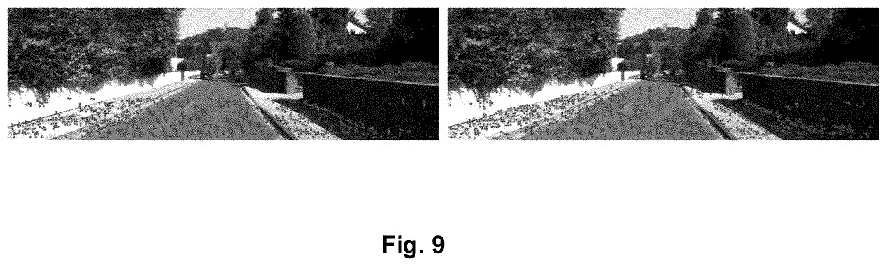

Furthermore with reference to the example immediately above, it will be appreciated that a max pooling technique can be employed to avoid overly crowded query keypoint detection. In this regard, the top-K points with the highest confidence score from the fused confidence map can be selected as keypoints. In doing so, the fused confidence map can be partitioned into smaller patches, by example of a size 8×8, while enforcing a limit of one detected query keypoint per patch. This approach may allow for the selected query keypoints to be well-distributed across the ground plane, thereby improving the accuracy of any sub sequent pose estimation, as discussed further herein. An example of query keypoints detected in this manner are shown on the right-hand side of FIG. 9, as discussed further herein below.

At step 360, the processing device maps the query keypoints to matching aerial keypoints in the aerial feature map using the trained computational model. In this regard, the computational model can be trained to have at least one parameter adjusted to adapt for a domain variation between the ground-based query image and the aerial image towards mapping the query keypoints to the matching aerial keypoints. In one example, this adjustment can be a function of a variance in focal length of a camera that captured the ground-based query image and a camera that captured the aerial image. By example, the computational model can be trained to explicitly enforce view-invariant query and aerial feature maps based on L2 loss functions in three feature spaces to determine a query feature representation loss, an aerial feature representation loss and a latent feature representation loss. In this regard, the query feature representation loss can be calculated during training based on an average of the squared difference between ground truth aerial keypoints of the aerial feature map, projected to and from a latent feature space guided by a focal length of the cameras that captured the aerial image and ground-based query image respectively, and matched query keypoints of the query feature map. The aerial feature representation loss can be calculated during training based on an average of the squared difference between query keypoints, projected to and from the latent feature space guided by focal length of the cameras that captured the ground-based query image and aerial image respectively, and matched ground truth aerial keypoints. Finally, the latent feature representation loss can be calculated during training based on an average of the squared difference between query keypoints, projected to the latent feature space guided by focal length of the camera(s) that captured the ground-based query image, and ground truth aerial keypoints, projected to the latent feature space guided by focal length of the camera that captured the aerial image.

The computational model may further be trained to have at least one parameter adjusted to adapt for a perspective variation between the ground-based query image and the aerial image towards mapping the query keypoints to the matching aerial keypoints. In one example, the at least one parameter is adjusted during training to adapt for perspective variation to account for a variance between a mapped query keypoint and a matching ground truth aerial keypoint as a function of a distance between the matching ground truth aerial keypoint and a ground truth pose of the imaging device within the aerial feature map, such as a ground truth pose determined by GPS data during training.

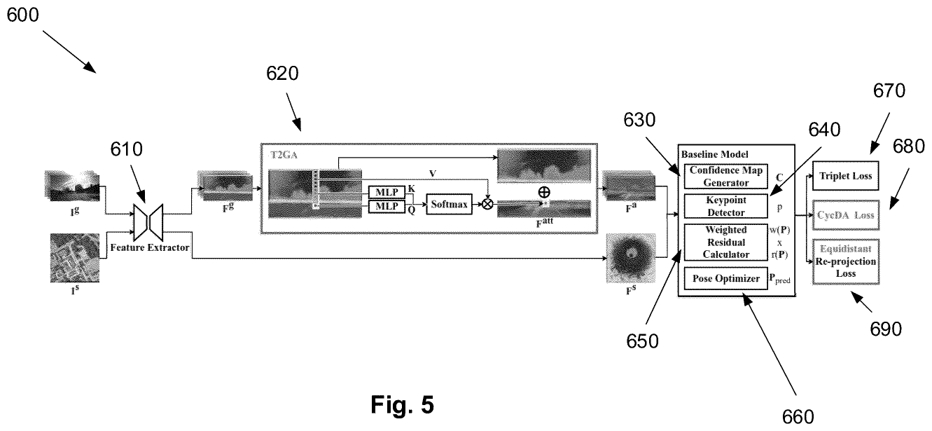

A further specific and non-limiting example of a method and system for localising a ground-based query image captured by an imaging device with respect to an aerial image of a physical environment within which the imaging device is disposed, therewith enabling a pose of the imaging device to be determined within the physical environment, will now be described with reference to FIG. 5.

Specifically, the following presents an image localisation method 600 and system for a vehicle traversing an urban environment.

The method in accordance with this specific example is herein after referred to as the “current” method for ease of reference. This current method aims to achieve fine-grained cross-view localization (FGCVL) by accurately estimating the 3-DoF pose of the vehicle, denoted by P_{pred}={ϕ_{pred}>φ_{pred}, θ_{pred}}, where ϕ and φ represent lateral and longitudinal translations, respectively, and θ is the yaw angle. A coarse initial pose Pᵢₙᵢₜ={ϕᵢₙᵢₜ, φᵢₙᵢₜ, θᵢₙᵢₜ} is given as well as a reference aerial image I^{S}, such as a satellite image, and a set of ground-based query images

$${I}^{g} = {\{ {I}^{i} \}}_{i = 1}^{N}$$

captured by camera(s) onboard the vehicle, where N is the total number of onboard cameras. It will be appreciated from the following description that the current method supports varying onboard camera quantities.

The FGCVL task therewith aims to estimate the accurate 3-DoF pose of the vehicle, including longitudinal and lateral translations and orientation on the aerial image I^{S}, given an initial coarse pose Pᵢₙᵢₜ.

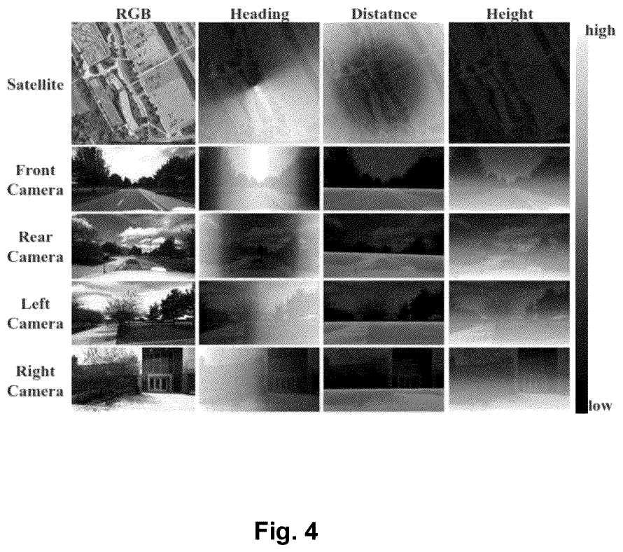

In this regard, a spatial embedding is first performed on the aerial image I^{S} and ground-based query images I^{g} as depicted in FIG. 4. The spatial embedding may be in part based on the spatial embedding concept discussed in [11] using ‘azimuth’ and ‘altitude’. In this regard, the spatial embedding in accordance with this example can constitute an improved spatial embedding concenpt that extends to a spatial embedding E^{g}/s∈ [symbol] ^{h×w×3} performed in accordance with the three channels: heading, distance and height. In brief, heading is embedded using the cosine of its angle, distance is embedded as the normalized on-ground distance from the imaging device, with the assumption that a pixel in the image is lying on the ground and height is normalized on a vertical axis of coordinates for the ground-based query image and set to a minimal or negligible value for the aerial image to indicate a substantially top-down view.

In one example, to incorporate spatial embedding information between the ground-based query image and aerial image, pixels in the ground-based query image and aerial image are transformed into a common set of query world coordinates using the coarse initial pose Pᵢₙᵢₜ={ϕᵢₙᵢₜ>φᵢₙᵢₜ, θᵢₙᵢₜ}, by example as based on the GPS coordinates of the vehicle. In this coordinate system, the x-axis corresponds to the direction of motion of the vehicle, the y-axis points to the right of the vehicle, and the z-axis points downward from the camera(s) onboard the vehicle. In performing this transformation, an inverse projection formula shown as shown in equation (1) can be used.

$${P}_{3 D}^{j 2 g} = {R}_{j 2 g} {K}_{j}^{- 1} ( {p}_{2 D}^{j} ⊕ 1 ) \qquad ( 1 )$$

Here Kⱼ is the intrinsic matrix of camera j, which can be either the onboard camera(s) or that which captured the aerial view

$$j ∈ \{ {i}_{1}^{N} , s \} ,$$

and ⊕1 concatenates 1 to generate a homogeneous coordinate. Here, the rotation for the aerial image, from camera j which captured the aerial image, to the coordinate for the ground-based query image, R_{j2g}, is obtained from extrinsic information available for the onboard camera(s) and an initial coarse pose Pᵢₙᵢₜ={ϕᵢₙᵢₜ, φᵢₙᵢₜ, θᵢₙᵢₜ}. For the ground-based query image, the 3D coordinate

$${P}_{3 D}^{j 2 g}$$

is a homogeneous coordinate with an unknown scale, while for the aerial image,

$${P}_{3 D}^{s 2 g}$$

represents a world coordinate with an unknown down axis. This is as the aerial image is approximated as a parallel projection, and the equation for the calculating

$${P}_{3 D}^{s 2 g}$$

is:

$${P}_{2 D}^{s} = ( \begin{matrix}1 / γ & 0 & {c}_{u} \\ 0 & 1 / γ & {c}_{v}\end{matrix} ) {P}_{3 D}^{s} \qquad ( 2 )$$

Here, (cᵤ, cᵥ) represents the center of the aerial image, and γ represents the meter-per-pixel ratio calculated using:

$$γ = {\tilde{r}}_{earth} \times \frac{cos ( \tilde{L} \times \frac{π}{180 °} )}{{2}^{\tilde{z}} \times \tilde{s}} \qquad ( 3 )$$

Here, \tilde{r}ₑₐᵣₜₕ is an approximated radius of the Earth, \tilde{L} is the latitude, \tilde{z}=18 and \tilde{s}=2 is the zoom factor and a scale associated with the aerial image, such as that of Google Maps where the aerial image is retrieved from Google Maps in accordance with a non-limiting example as further exemplified herein under Experimental.

The heading information is embedded using the cosine value, which is symmetric to both positive and negative orientation noise. This enables distinction between 360-degree views, calculated using the x-axis

$${P}_{3 D}^{j 2 g} [ 0 ]$$

and y axis

$${P}_{3 D}^{j 2 g} [ 1 ]$$

through trigonometric functions:

$${E}^{j} [ 0 ] = \frac{{P}_{3 D}^{j 2 g} [ 0 ]}{\sqrt{{{P}_{3 D}^{j 2 g} [ 0 ]}^{2} + {{P}_{3 D}^{j 2 g} [ 1 ]}^{2}}} \qquad ( 4 )$$

The normalized distance embedding of the ground-based query image is obtained by an initial assumption that all pixels lie on the ground plane:

$${E}^{j} [ 1 ] = \frac{\sqrt{{{P}_{\tilde{3 D}}^{j 2 g} [ 0 ]}^{2} + {{P}_{\tilde{3 D}}^{j 2 g} [ 1 ]}^{2}}}{𝒟} \qquad ( 5 )$$

Here [symbol] is a maximum visible distance based on an area of the physical environment covered by the aerial image and:

$${P}_{\tilde{3 D}}^{i2g} = \frac{{h}_{i}}{{P}_{3 D}^{i 2 g} [ 2 ]} \times {P}_{3 D}^{i 2 g} and {P}_{\tilde{3 D}}^{s 2 g} = {P}_{3 D}^{s 2 g} + {t}_{s 2 g} \qquad ( 6 )$$

Here hᵢ is an onboard camera height relative to a ground plane. For the ground-based query image, the height embedding E[2] is equal to the value along the down axis, represented as

$${P}_{3 D}^{i 2 g} [ 2 ] .$$

In the case of the aerial image, the height embedding can be set to the minimal or negligible value to indicate a substantially top-down perspective.

As shown in FIG. 5, a “Feature Extractor” 610 may therewith be provided, such as based on a two-branch shared weight architecture, by non-limiting example a Siamese-type two-branch convolutional neural network as discussed in [11] or other DeepNet methods such as the above-described Transformer based on [24] or MLP, with the improved spatial embedding as discussed above.

This Feature Extractor 610 can therewith be configured to extract query features and aerial features, as spatially aware deep features, in the form of a query feature map F^{g} and an aerial feature map F^{s} respectively. Towards this purpose, the Feature Extractor 610 may employ a U-Net structure ( [symbol] ), although those skilled in the art will appreciate that this structure need not necessarily be employed.

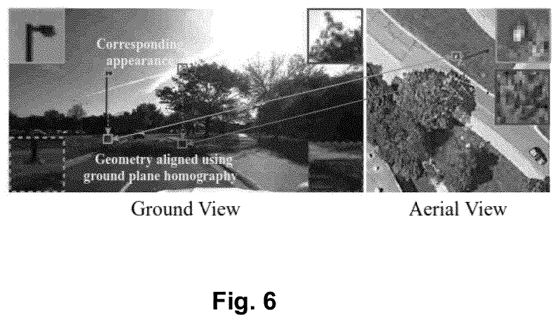

In this regard, the appearance discrepancy between the same objects from the ground-based query image and the aerial image perspectives presents a significant challenge in achieving high precision in the FGCVL task, for example as faced in [16], [19] and [28]. This issue is often encountered on tall structures, e.g. street light, and the occlusion from aerial objects, e.g. tree branches, where their near (on)-ground appearance, accessible to only on-board vehicle camera, is significantly different from their top appearances which are only registered in the aerial image (as shown in FIG. 6). Such discrepancies are common on roads and can lead to inaccuracies in cross-view localization. To address this challenge, the current method aligns the representations between ground-based query image and aerial image, focusing specifically on the on-ground pixels, where geometry alignment across the two images hold due to the ground plane homography. Specifically, Top-to-Ground Aggregation 620, shown as box “T2GA” in FIG. 5, is included that aggregates pixels associated with elevated features of the query feature map F^{g} from the ground-based query image onto a ground-plane pixel that is directly beneath them.

In this regard and for a ground-plane pixel:

$$p ∈ {\{ ( u , v ) \}}_{u = 0 , v = T}^{{W}^{g} - 1 , {H}^{g} - 1} \qquad ( 7 )$$

Here T is a threshold corresponding to the height of horizon in the ground-based query image, and W^{g} and H^{g} are the width and height of the ground-based query image, respectively. The corresponding elevated pixels are:

$$q ∈ {\{ ( {u}_{p} , v ) \}}_{v = 0}^{{v}_{p}} \qquad ( 8 )$$

Here (uₚ, v) are the coordinates of the ground-plane pixel p. This aggregation may be achieved via an attention mechanism based on [24], defined as:

$${F}^{att} [ p ] = Softmax ( {QC}^{T} ) V \qquad ( 9 )$$

Here F^{att}[p] represents the feature vector at a pixel p on a feature map F^{att}. In this context, p and q denote a ground-plane pixel and its corresponding elevated pixels, respectively. The query is formed by taking the features of ground-plane pixels Q= [symbol] (F^{g}[p]) where [symbol] (⋅) represents a non-linear mapping consisting of a Multilayer Perceptron (MLP) layer followed by an activation function. The value is derived from the features of elevated pixels corresponding to the ground-plane pixel V=F^{g}[q], and the key is then obtained by applying the same non-linear mapping to V, resulting in K= [symbol] (V). This non-linear mapping ensures that the query and key are mapped to the same feature space before computing their matrix product, QK^{T}. In processing all query pixels, the matrix multiplication QK^{T} is first computed using all column pixels

$$q ∈ {\{ ( u , v ) \}}_{v = 0}^{{H}^{g} - 1} .$$

The attention values corresponding to pixels below each query pixel

$${\{ ( {u}_{p} , v ) \}}_{v = {v}_{p} + 1}^{{H}^{g} - 1}$$

are then eliminated. After this elimination, the Softmax function is applied.

Notably, value V is used directly in its original form for the computation, facilitating a straightforward fusion (for the same object) or replacement (in cases of occlusion) at the ground plane.

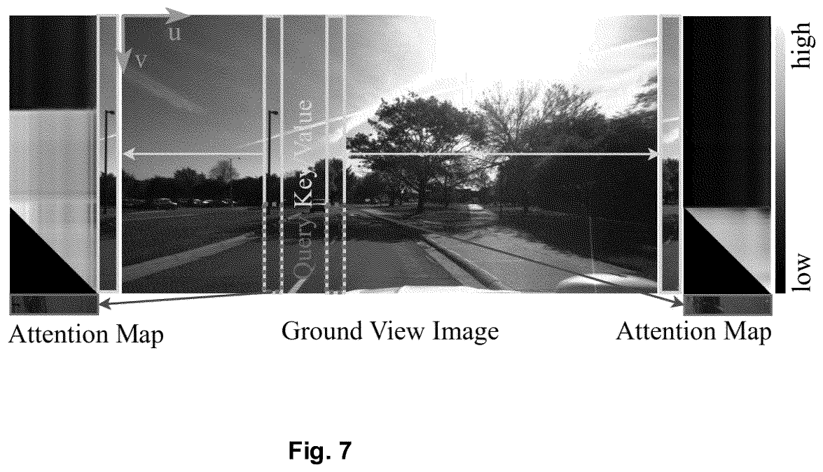

The computed attention map Softmax (QK^{T}) can accurately reflect the connection between the ground-plane pixels and their corresponding elevated pixels. As illustrated in FIG. 7, high attention values are assigned to the base and top of the streetlight despite their different appearances. This provides important cues to alleviate the representation gap between features of the ground-based query image and features of the aerial image. On the other hand, in the absence of occlusion, e.g. tall structure and tree branch, thus the attention between ground-plane and elevated pixels is minimal, avoiding diluting features of the ground-based query image that are well aligned with their aerial image counterparts.

The feature map F^{att} after attention calculation is vertically stacked with the upper part of the original F^{g} to generate an aggregated feature map F^{a}:

$${F}^{a} = {F}_{0 : {H}^{g} - T}^{g} ⊕ {F}^{att} \qquad ( 10 )$$

Here ⊕ denotes vertically stacking and

$${F}_{0 : {H}^{g} - T}^{g}$$

indicates the slicing of F^{g} from row 0 to H^{g}−T. Subsequently, this aggregated feature map F^{a} is used in the residual calculation as per equation (11) as discussed further below.

The aggregated feature map F^{a} and aerial feature map F^{s} are then processed by a Confidence Map Generator 630, as shown in FIG. 5, as by example a 1×1 kernel convolutional layer outputting confidence values in a range from 0 to 1 in an array matching the size of the image to which they pertain, followed by a reverse sigmoid active function (c_{ψ}) to produce view-consistent confidence maps and on-ground confidence maps. It will however be appreciated that various mechanisms may be employed as a Confidence Map Generator towards the above purpose in generating confidence values.

The Confidence Map Generator 630 therewith produces two types of confidence maps: view consistent confidence maps V={V^{s}, V^{g}} and on-ground confidence maps O={O^{s}, O^{g}}. The former assigns high confidence to features or “objects” consistent across both the ground-based query image and the aerial image, while the latter focuses on on-ground objects. The overall confidence is represented as C=V×O, integrating both view consistency and on-ground feature or object emphasis. Those skilled in the art will appreciate that, in this manner, feature extraction 620 and confidence map generation 630 from each image can be performed in parallel using the shared-weight model, which allows for a flexible number of onboard cameras. It will however further be appreciated by those in the art that feature extraction and confidence map generation within the scope of the present disclosure can be performed by other means and/or architectures.

The advantage of the aggregated feature map F^{a} is indirectly reflected by a comparison between a confidence map C^{g} produced from a query feature map F^{g} (as shown on the left-hand side of FIG. 8) as opposed to a confidence map C^{g} produced from the aggregated feature map F^{a} (as shown on the left-hand side of FIG. 8), illustrating the effect of T2GA 620 on the resultant confidence map C^{g}. The confidence map without T2GA (left in FIG. 8) predominantly highlights road marks and curbs, missing important road landmarks, e.g. traffic signal poles, that provide important cues to vehicle pose estimation; The confidence map with T2GA (right in FIG. 8) has high-confidence values distributed across various road marks and traffic poles. With more geographic cues provided by multiple sources, the resultant pose prediction becomes more precise and robust.

Consequently, a share-weight U-Net Feature Extractor 610, T2GA 620 and Confidence Map Generator 630 can be employed to extract ground-based and aerial feature maps F={F^{g}, F^{s}}, establish F^{a} from F^{g} and therewith generate ground and aerial confidence maps C={C^{g}, C^{s}} from spatially embedded aerial and ground-based query images I©E, where I={I^{g}, I^{s}}.

As further shown in FIG. 5, a Keypoint Detector 640 is provided. It will be appreciated that various keypoint or interest point detection techniques for 2D applications may be employed in this regard, by non-limiting example including SuperPoint as discussed in Daniel DeTone, Tomasz Malisiewicz, and Andrew Rabinovich, “Superpoint: Self-supervised interest point detection and description”, CoRR, abs/1712.07629, 2017. In one example, and the Keypoint Detector 640 can be configured to select the top-N most confident pixel-level points p^{g} from F^{a} at the positions

$${p}^{g} = {\{ ( {u}_{i}^{g} , {v}_{i}^{g} ) \}}_{i = 1}^{N}$$

based on the confidence maps, i.e. the Keypoint Detector selects the top-N points p^{g} with the highest confidence, at least in part, based on the confidence map C^{g}.

These keypoints are converted into 3D coordinates p within the vehicle world or on-board camera coordinate system, leveraging their ground-plane or “on-ground” characteristics. Following this, a Weighted Residual Calculator projects these 3D points to aerial coordinates and onto the aerial view using

$${p}_{i}^{s} ( P ) = {K}_{s} {PK}_{g}^{- 1} {p}_{i}^{g} ,$$

where Kₛ and K_{g} are the intrinsic matrices of aerial and on-board cameras, respectively. P is the initial pose Pᵢₙᵢₜ at the first iteration and the estimated pose P_{pred} in the subsequent iterations.

In this regard, p^{s}=KₛPp retrieves the point weight {C^{s}[p^{s}(P)], C^{g}[p^{g}]} and point feature vector {F^{s}[p^{s}(P)], F^{a}[p^{g}]} from the confidence and feature maps, respectively. A weighted residual w(P)×r(P) is then computed by a Weighted Residual Calculator 650 between the top-N selected features from the ground feature map and the corresponding features from the satellite feature map as:

$$w ( P ) = {C}^{s} [ {p}^{s} ( P ) ] \times {C}^{g} [ {p}^{g} ] , r ( P ) = {F}^{s} [ {p}^{s} ( P ) - {F}^{a} [ {p}^{g} ] \qquad ( 11 )$$

Here [⋅] is a lookup operation in a feature/confidence map with sub-pixel interpolation.

Finally, the vehicle's pose P_{pred} may be iteratively refined by a Pose Optimizer 660, for example using the Levenberg-Marquardt (LM) algorithm based on Jorge J Moré, “The levenberg-marquardt algorithm: implementation and theory”, Numerical analysis: proceedings of the biennial Conference held at Dundee, Jun. 28-Jul. 1, 1977, pages 105-116. Springer, 2006 (“[12]”) so as to take the computed weighted residual w(P)×r(P) as input and output the predicted vehicle pose P_{pred}. It will be appreciated by those skilled in the art that various optimizers, such as Gaussian-Newton or gradient descent optimizers, may be employed in this regard and the Pose Optimizer 660 need not use the LM algorithm.

The process of (i) projecting the top-N points p^{g} onto the aerial image using on-board camera coordinates to aerial coordinates, (ii) computing a weighted residual between the top-N selected features and (iii) outputting the predicted vehicle pose P_{pred} is repeated, by example, for M=20 iterations to produce the final vehicle pose P_{pred}, where in each iteration

$${P}_{pred}^{m}$$

is P_{pred} at the m^{th} iteration, with m∈{1, . . . , M}.

In a particular example wherein the Pose Optimizer 660 uses the LM algorithm, pose optimization 660 can be performed iteratively using the equation below:

$${δ}_{t + 1} = {δ}_{t} - {( H + λ diag ( H ) )}^{- 1} {J}^{T} W ϒ \qquad ( 12 )$$

Here δ represents an individual element in the 3-DoF pose. The current iteration is represented by t∈{1, . . . , M×L}, where M is the iteration count per level and L is the total number of levels. The damping factor λ follows the definition as discussed in Paul-Edouard Sarlin, Ajaykumar Unagar, Mans Larsson, Hugo Germain, Carl Toft, Viktor Larsson, Marc Pollefeys, Vincent Lepetit, Lars Hammarstrand, Fredrik Kahl, and Torsten Sattler, “Back to the Feature: Learning robust camera localization from pixels to pose”, CVPR, 2021 (“[14]”). The matrices W∈ [symbol] ^{NN} and γ∈ [symbol] ^{ND} are constructed by stacking all point weights W=diag(w(P)ρ′) and residuals r(P), respectively, with ρ′ being the derivative of the robust cost function as discussed in Frank R Hampel, Elvezio M Ronchetti, Peter J Rousseeuw, and Werner A Stahel, “Robust statistics: the approach based on influence functions”, John Wiley & Sons, 2011 (“[7]”). The Jacobian J and Hessian matrices H are defined as shown below:

$$J = \frac{\partial r ( P )}{\partial δ} \frac{\partial {F}^{s} [ {p}^{s} ( P ) ]}{\partial {p}^{s} ( P )} \frac{\partial {p}^{2} ( P )}{\partial δ} , H = {J}^{T} WJ \qquad ( 13 )$$

In this regard, two loss functions may be employed: a Triplet Loss 670 based on in Qi Qian, Lei Shang, Baigui Sun, Juhua Hu, Hao Li, and Rong Jin, “Softtriple loss: Deep metric learning without triplet sampling”, Proceedings of the IEEE/CVF International Conference on Computer Vision, pages 6450-6458, 2019 (“[13]”), designed to enhance pose-sensitive feature extraction, and a Re-projection Loss, which encourages the predicted pose P_{pred} to closely align with a ground truth P_{gt}. The former therewith supervises the weighted residual, enforcing that pose-sensitive features are extracted from both ground-based query image and aerial images. The later utilises the projection error w.r.t the ground truth pose P_{gt} to penalize incorrectly predicted vehicle pose P_{pred}.

A form of a Re-projection Loss is detailed as per equation 14 below while the formulation of the Triplet Loss is detailed as per equation 15 below.

$${L}_{RP} = \frac{1}{N} {\sum }_{i = 1}^{N} {‖ {p}_{i}^{s} ( {P}_{pred} ) - {p}_{i}^{s} ( {P}_{gt} ) ‖}_{2}^{2} \qquad ( 14 )$$

$${L}_{TRP} = log ( 1 + {e}^{α ( 1 - \frac{ε ( {P}_{init} )}{ε ( {P}_{gt} )} )} ) , ε ( P ) = {\sum }_{p} w ( P ) \times ρ ( {‖ r ( P ) ‖}_{2}^{2} ) \qquad ( 15 )$$

In equation (14),

$${p}_{i}^{s} ( {P}_{pred} ) and {p}_{i}^{s} ( {P}_{gt} )$$

are the projected coordinates on the aerial image from the selected top-N ground keypoints with the predicted vehicle pose and the ground truth vehicle pose respectively, and ∥⋅∥₂ denotes the L2-distance.

In equation (15), α is a margin-controlling hyper-parameter, the summation Σₚ aggregates over all keypoints, and ρ(⋅) denotes the robust cost function discussed in [7].

However, there are multiple sources responsible for the representation gap between features or objects in the ground-based query image and the aerial image. In addition to the varying appearances of the same object across different views, camera specifications, e.g. tone, hue, intensity, brightness and resolution, and temporal changes of varying spans, can also lead to inconsistent representations for the same geographic location. Such issue is in general overlooked by the existing FGCVL methods, by example as in [16] and [30]. Despite introducing a triplet loss to further distinguish feature representations based on different poses, FGCVL can fall short in enforcing invariant feature representation at the corresponding geographic locations across different views. Accordingly, as shown in FIG. 5, a Cycle Domain Adaptation (CycDA) loss 680 is proposed by the current method to explicitly enforce view-invariant representations.

CycDA loss 680 explicitly enforces view-invariant representations and consists of three L2-loss between ground-based query or “ground” and aerial or “satellite” feature representations in three different feature spaces. The representation loss in the query or “ground” feature space is defined as:

$${ℒ}_{g} = \frac{1}{N} {\sum }_{i = 1}^{N} {‖ {F}^{a} [ {p}_{i}^{g} ] - 𝒟 ( ε ( {F}^{s} [ {p}_{i}^{s} ( {P}_{gt} ) ] © {c}_{s} ) © {c}_{g} ) ‖}_{2} \qquad ( 16 )$$

Here ε(⋅) is a projection from the pixel feature space to a latent feature space, [symbol] (⋅) is a projection from the latent feature space to the pixel feature space, cₛ and c_{g} represent the focal length of the aerial camera and vehicle camera respectively which are introduced to guide the projection functions, and © is a concatenation acting on the feature channel dimension. Similarly, the representation loss in the aerial or “satellite” feature space is:

$${ℒ}_{s} = \frac{1}{N} {\sum }_{i = 1}^{N} {‖ {F}^{s} [ {p}_{i}^{s} ( {P}_{gt} ) ] - 𝒟 ( ε ( {F}^{a} [ {p}_{i}^{g} ] © {c}_{g} ) © {c}_{s} ) ‖}_{2} \qquad ( 17 )$$

The current method also enforces the aerial feature to be aligned with the ground-based query feature corresponding to the same geographic location in a latent feature space through:

$${ℒ}_{m} = \frac{1}{N} {\sum }_{i = 1}^{N} {‖ ε ( {F}^{a} [ {p}_{i}^{g} ] © {c}_{g} ) - ε ( {F}^{s} [ {p}_{i}^{s} ( ( {P}_{gt} ) ] © {c}_{s} ) ‖}_{2} \qquad ( 18 )$$

The overall CycDA loss can then be defined as:

$${ℒ}_{CycDA} = {ℒ}_{g} + {ℒ}_{s} + {ℒ}_{m} \qquad ( 19 )$$

Furthermore, and despite being effective in pipelines where simultaneous detection of keypoints is not required, by example as in Andrew J Davison, Ian D Reid, Nicholas D Molton, and Olivier Stasse, “Monoslam: Real-time single camera slam”, IEEE transactions on pattern analysis and machine intelligence, 29 (6): 1052-1067, 2007 (“[3]”), Shinya Sumikura, Mikiya Shibuya, and Ken Sakurada, “Openvslam: A versatile visual slam framework”, Proceedings of the 27th ACM International Conference on Multimedia, pages 2292-2295, 2019 (“[20]”) and [27], the above noted re-projection loss according to equation (14) tends to overly penalize the orientation errors of distant points. This forces the detected keypoints being closer to the vehicle and less accurate vehicle orientation estimation. Accordingly, a re-projection loss as an Equidistant Re-Projection (ERP) loss 690 is proposed by the current method to mitigate the aforementioned issue.

The current method addresses a challenging setting of simultaneously detecting keypoints from the ground image and predicting the vehicle pose using the detected keypoints. In this context, and as shown in FIG. 5, an Equidistant Re-Projection (ERP) loss 690 is proposed that allows for a more dispersed distribution of keypoints, as the top-N points p^{s} with the highest confidence from the ground view confidence map C^{g}.

The ERP loss is defined as:

$${ℒ}_{ERP} = \frac{1}{N} {\sum }_{i = 1}^{N} ‖ \frac{{p}_{i}^{s} ( {P}_{pred} ) - {p}_{i}^{s} ( {P}_{gt} )}{{D}_{{p}_{i}^{s}}} ‖ \qquad ( 20 )$$

Here

$${D}_{{p}_{i}^{s}} {‖ {p}_{i}^{s} ( {P}_{gt} ) - {p}_{vehicle}^{s} ( {P}_{gt} ) ‖}_{2}$$

is the L2-distance between the aerial image coordinates of the i^{th} keypoint and the vehicle. The design prevents the orientation error from scaling with the L2-distance between keypoints and vehicle on the aerial image, which dominates over the orientation error on distant keypoints. As shown in FIG. 9, the current method can therewith leverage keypoints that are farther from the vehicle (right in FIG. 9) than would be achievable in the absence of an ERP loss (left in FIG. 9).

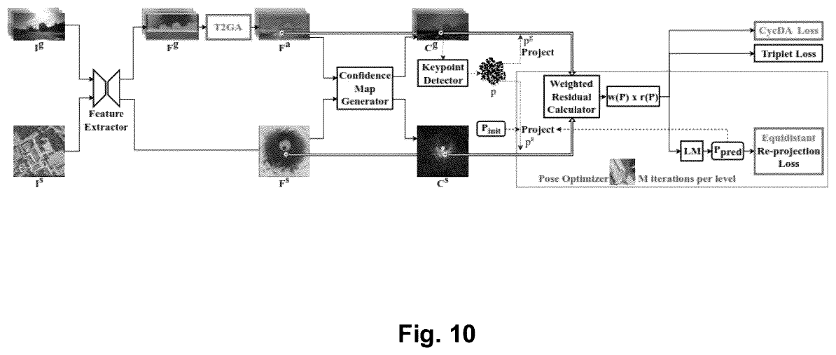

A more detailed overview of the architecture of the current method is therewith provided in FIG. 10. In this regard, it can be seen that the current method employs the dual-branch structure, with one branch dedicated to ground-based query images and the other to aerial images. A shared-weight Feature Extractor extracts feature maps F={F^{g}, F^{s}} from each input image I={I^{g}, I^{s}}. The T2GA generates F^{a} from F^{g}. The Confidence Map Generator then produces confidence maps C={C^{g}, C^{s}} for each feature map F={F^{a}, F^{s}}, with ground-based query confidence maps C^{g} utilized by the Keypoint Detector to identify high-confidence keypoints. These keypoints are projected into 3D space and subsequently re-projected onto the aerial image by the Weighted Residual Calculator. The Pose Optimizer refines the vehicle's pose P_{pred}, such as by using the Levenberg-Marquardt algorithm over M iterations at each level, from coarse to fine. The current method's architecture therewith integrates the CycDA Loss and Triplet Loss for view-invariant feature representation, along with the Equidistant Re-projection Loss, which normalizes the influence of distant keypoints and encourages the predicted pose P_{pred} to closely align with the ground truth P_{gt}.

Therewith, the current method introduces T2GA that employs top-down feature aggregation to enrich on-ground points, or pixels at the ground-plane, with an above-view perspective appearance, improving feature alignment and localization accuracy, as described above. Furthermore, it is recognised that pixel positions above ground points may not necessarily indicate higher elevations; instead, they could represent objects located further along the vehicle camera's line of sight. To resolve this ambiguity, a transformer mechanism is integrated that assesses whether these pixels belong to the same object and determines occlusion precedence, such as shadows on the road, which suggest likely occlusions in the aerial image.

In addition to viewpoint differences, ground-based query images or “ground views” and aerial images differ in camera types, lighting conditions, tones, and resolutions. The CycDA loss function is introduced to address these variations. CycDA enables bidirectional feature generation between ground-based query and aerial images. By minimizing the discrepancy between domain-adapted features and their target counterparts, the current method can ensure that features extracted from one domain are effectively translatable to the other, fostering the extraction of features that are invariant across domains.

The ERP loss is further introduced to address a common bias in keypoint-synchronous detection localization methods, which tend to favour closer keypoints due to their reduced orientation errors. The ERP loss function mitigates this issue by applying a distance-weighted approach, ensuring that orientation errors are independent of keypoint distance. Consequently, keypoints are more uniformly distributed across various distances, leading to a more equitable and precise estimation of direction.

Aspects of the current method thereby may effectively bridge the domain gap between ground-based query and aerial images by utilizing off-road cues and handling occlusions, introduce a loss function that promotes domain-invariant feature extraction, enhancing the robustness of cross-view localization methods, and a loss function that ensures orientation errors are consistent regardless of keypoint distance, leading to a more extended distribution of keypoints and more accurate orientation estimation.

In view of the above and in estimating the accurate 3-DoF pose of a vehicle, the current method accordingly proposes a novel View From Above (VFA) method to tackle the FGCVL task by aligning feature representations across ground-based query images and aerial images.

### Experimental

In the following sections and the accompanying figures, reference to the “baseline model” or “PureACL” is with reference to a method performed in accordance with the above disclosure but without employing T2GA, CycDA or ERP loss. Furthermore, ground-based query images and aerial images are discussed with non-limiting reference to “ground views” and “satellite views” respectively.

Datasets: To evaluate the current method, experiments were conducted on two well-established autonomous driving datasets: the Ford Multi-AV Seasonal dataset (FMAVS), as discussed in Sidharth Agarwal, Ankit Vora, Gaurav Pandey, Wayne Williams, Helen Kourous, and James McBride, “Ford multi-AV seasonal dataset”, The International Journal of Robotics Research, 39 (12): 1367-1376, 2020 (“[1]”) and the KITTI dataset as discussed in Andreas Geiger, Philip Lenz, Christoph Stiller, and Raquel Urtasun, “Vision meets robotics: The kitti dataset” The International Journal of Robotics Research, 32 (11): 1231-1237, 2013 (“[5]”). The primary focus is on images from the front left camera as ground-based query images. Additionally, the analysis was broadened to include four camera perspectives: front left, rear right, side left, and side right. For data partitioning in the KITTI-CVL dataset, an approach was utilized in line with HighlyAcc as discussed in [16], which involves two test splits. The first, ‘Same,’ includes images from the same trajectories as the training dataset, while the second, ‘Cross,’ comprises images from distinct trajectories. Regarding the FMAVS dataset, a partitioning strategy using all images from the same trajectories but different traversals was followed. It is noteworthy that there are minor route variations within these same trajectories.

Metrics: Evaluation metrics were adopted in line with HighlyAcc of [16], SliceMatch of [10], SIBCL of [27]. The precision assessment includes median and mean errors for overall, lateral, and longitudinal translations, as well as orientation accuracy. Additionally, the analysis covers lateral and longitudinal translations and localization recall at various distances (0.25 m, 0.5 m, 1 m, 3 m, and 5 m), and orientation recall within a range of 1° to 5°.

Training Details: Two sets of criteria were applied: (1) Following HighlyAcc of [16], ground images are processed at a resolution of 256×1024, and satellite images at 512×512, with initial pose noise ±10° for orientation and ±20 m for translations. (2) FMAVS images were processed at 432× 816, KITTI images at 384×1248, and satellite images at 1,280×1,280. To better simulate turning scenarios, an expanded initial pose noise range of +45° was adopted for orientation and ±20 m for translations. For training, an NVIDIA RTX 3090 GPU was utilised with a batch size of 3, employing the Adam optimizer as discussed in Diederik P Kingma and Jimmy Ba, “Adam: A method for stochastic optimization”, arXiv preprint arXiv: 1412.6980, 2014 (“[9]”) with a learning rate of 10⁻⁵. Feature extractor weights are initialised with the pre-trained weights from Shan Wang, Yanhao Zhang, Ankit Vora, Akhil Perincherry and Hengdong Li, “Satellite image based cross-view localization for autonomous vehicle”, 2023 IEEE International Conference on Robotics and Automation (ICRA), pages 3592-3599. IEEE, 2023, while other components are initialized randomly. Training iterations averaged around 285 ms, including 200 ms dedicated to optimization. The inference speed, subject to initial pose variability, averaged at 222 ms.

Comparison with Existing Methods

The current method was evaluated against recent visual-only approaches on the KITTI-CVL dataset following the metrics of HighlyAcc of [16]. The results are shown in FIG. 11 as a comparison on the KITTI-CVL Dataset Under Initial Noise Conditions (±10°, ±20 m). Results marked with ★ are sourced directly from the respective original papers. Those denoted by • indicate retraining of methods for consistent evaluation criteria alignment. - indicates that the corresponding data were not provided.

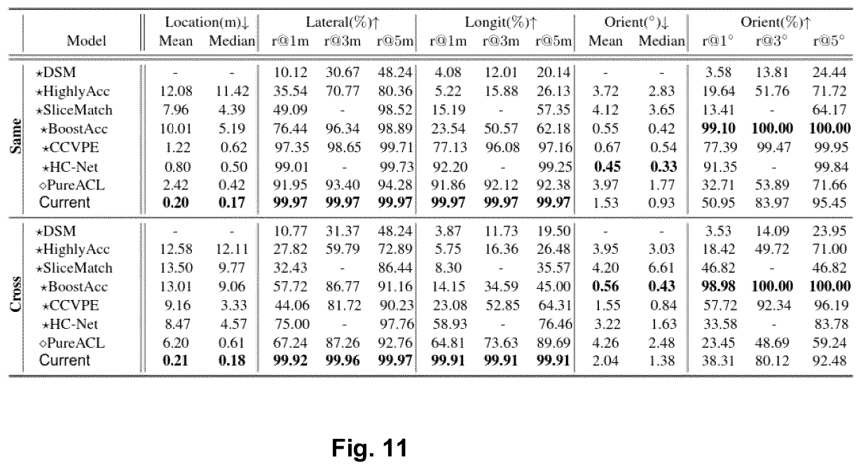

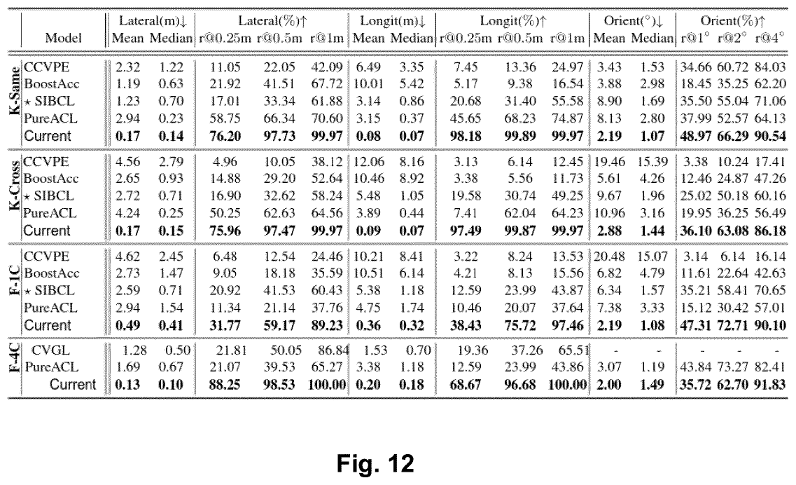

The table in FIG. 11 clearly indicates the superiority of the current method in spatial precision, consistently maintaining poses within a 1 m radius in both ‘Same’ and ‘Cross’ areas with over 99.9⁺% probability. While the current method may not lead in orientation accuracy under an initial pose range of ±10°, it demonstrates superior performance when the range is extended to ±45°, as shown in FIG. 12.

In this regard, FIG. 12 shows a comparison with Initial Noise Conditions (±45°, ±20 m). For the KITTI-CVL dataset, evaluations were conducted in ‘K-Same’ and ‘K-Cross’ areas. On the Ford-CVL dataset, the ‘Log 4’ trajectory, as used in SIBCL of [27], was chosen for its optimal satellite view alignment. ‘F-1C’ and ‘F-4C’ represent assessments on the Ford-CVL dataset using either a single front-facing camera or four surrounding cameras. A “★” in FIG. 12 indicates that SIBCL of [27] is a hybrid LiDAR-visual method.

FIGS. 11 and 12 therewith underline the robustness of the current method. The current method leverages pixel-wise localization, offering finer granularity compared to the patch-wise localization of SliceMatch of [10], CCVPE of [30], and the image-level localization of DSM of [17]. Although HighlyAcc of [16] and HC-Net of [28] are pixel-wise localization methods, their homography-based mechanisms fail to incorporate off-ground cues. In contrast, the current method effectively utilizes these cues, resulting in enhanced performance. Additionally, the current method's longitudinal estimation significantly surpasses that of BoostAcc in [19]. This improvement may be attributable to the current method's strategy of not aggregating information from pixels below, thereby reducing longitudinal ambiguity. Advantagously, the current method achieves significant enhancements in both orientation and spatial accuracy, especially in mean error reduction. Specifically, a 91⁺% reduction in spatial mean error and a 52⁺% reduction in orientation mean error are observed against the baseline model. The difference between mean and median errors for the baseline model indicates potential convergence issues in high-noise environments. By integrating T2GA and CycDA, the domain gap is bridged and ensures convergence even under challenging conditions.

### Challenge Initial Pose and Stringent Metrics

To rigorously evaluate the current method, stringent metrics which are more demanding than those used by HighlyAcc of [16] were adopted. The current method was benchmarked against SIBCL of and the baseline model, as well as SOTA methods CCVPE of [30] and BoostAcc of [19]. The results in FIG. 11 reaffirm the advantages of the current method, particularly in terms of reduced mean error and improved longitudinal estimation. Notably, under conditions of minimal initial pose noise (±15° and ±5 m), the baseline model outperforms SIBCL of [27]. However, when faced with more challenging conditions (±45° and ±20 m), the baseline model encounters convergence challenges, unlike the current method, which demonstrates consistent superiority.

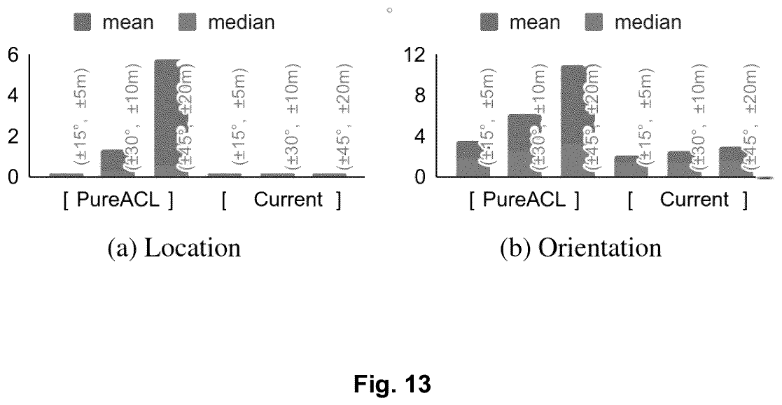

This highlights the effectiveness of the modifications proposed by the current method in feature alignment. Additionally, the current method's convergence range was assessed against the baseline model in the ‘Cross’ area of the KITTI-CVL dataset, as shown in FIG. 13 as a comparison of the baseline model and the current method under varying initial noise ranges in the ‘cross’ area of the KITTI-CVL dataset. The blue bar in FIG. 13 indicates the median value, while the red bar in FIG. 13 shows the difference between the median and mean values. Notably, the current method demonstrates robust convergence, outperforming the baseline model across all noise ranges, especially in larger noise scenarios where the baseline model shows significant discrepancies between median and mean values.

The red bar in FIG. 13 highlights a significant reduction in the gap between median and mean errors. This observation confirms the current method's enhanced ability to converge effectively across a wider range of noise levels.

Results with Continual Pose Estimation

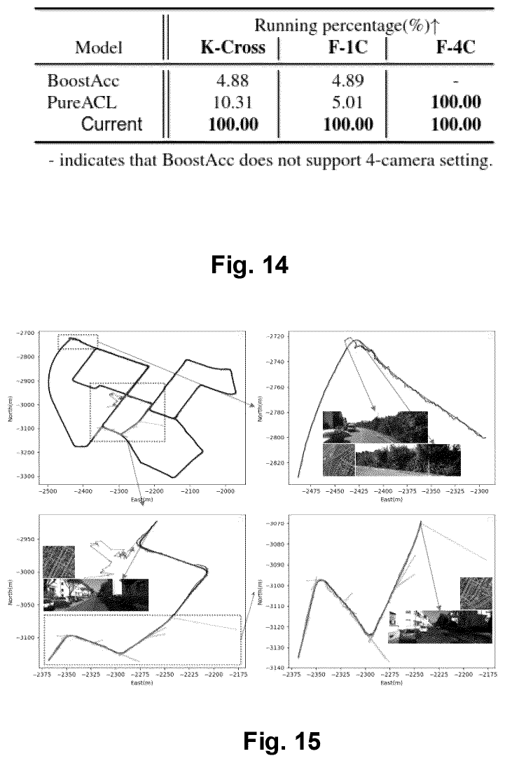

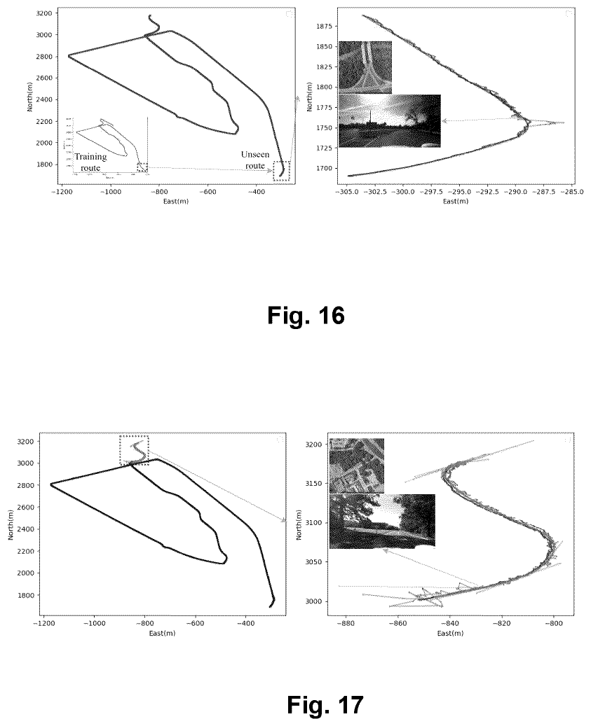

To address GPS signal loss, an accumulated pose estimation strategy was adopted that leverages initial poses based on the vehicle's previous pose estimates, with this pose estimation being purely frame-based and not involving any sequence-based filtering techniques. The current method used a model trained with initial noise allowances of ±45° and ±20 m. The current method's robustness is evidenced by the continuous running distance percentage shown in FIG. 14, showing successful pose chaining throughout all evaluated routes. In contrast, BoostAcc of [19] and the single-camera baseline model exhibit significant drift, leading to errors beyond the satellite map's coverage and causing evaluations to cease after covering less than 11% of the distance. Performance comparisons on the KITTI-CVL dataset are shown in FIG. 15 with performance comparisons on the Ford-CVL dataset further shown in FIGS. 16 and 17.

In this regard, FIG. 15 shows accumulated pose estimation performance on a KITTI CVL dataset trajectory.

Top-left of FIG. 15: Predicted poses by the current method (blue) closely match the ground truth (red) over the 3676-meter route, outperforming the baseline model (green) and BoostAcc (cyan), which exhibit severe drift.

Top-right of FIG. 15: The current model demonstrates rapid recovery upon encountering clear localization cues.

Bottom-left and bottom-right of FIG. 15: BoostAcc demonstrates substantial drift when encountering moving vehicles.

FIG. 16 shows performance of accumulated pose estimation using four surrounding cameras on the ‘Log 4’ trajectory (4189 meters) from the FordAV-CVL dataset.

Left in FIG. 16: The predicted poses by the current method are illustrated in blue, the baseline model in green, and the ground truth in red. Both the current method and the baseline model successfully estimate the pose throughout the entire route, including the unseen trajectory.

Right in FIG. 16: The current method consistently maintains close alignment with the ground truth, even in the unseen parts of the trajectory. In contrast, the baseline model experiences some drift but ultimately manages to recover and realign with the correct trajectory.

FIG. 17 shows accumulated pose estimation performance from a front camera on Ford-CVL dataset's ‘Log 4’ trajectory.

Left of FIG. 17: Predicted poses by the current method (blue) closely track the ground truth (red) along the entire route, outperforming the baseline model (green) and BoostAccurate of [19] (cyan), which exhibit severe drift.

Right of FIG. 17: The baseline model and BoostAccurate exhibit significant drift from a similar starting point with severe occlusions, leading to substantial position errors and eventual departure from the satellite map's coverage.

The current method consistently achieved accurate pose estimation or experienced only minor drifts in challenging scenarios characterized by limited localization cues or severe occlusions. In contrast, BoostAcc of [19] exhibited significant drift when a moving vehicle passes by, likely due to in correct query data from projected vehicle pixels. Furthermore, the baseline model appeared to struggle with incorrect orientation, resulting in reversed pose estimations. These outcomes highlight the importance of robustness in real-world applications, as drifts that extend beyond the coverage of satellite imagery can compromise all further pose estimation processes.

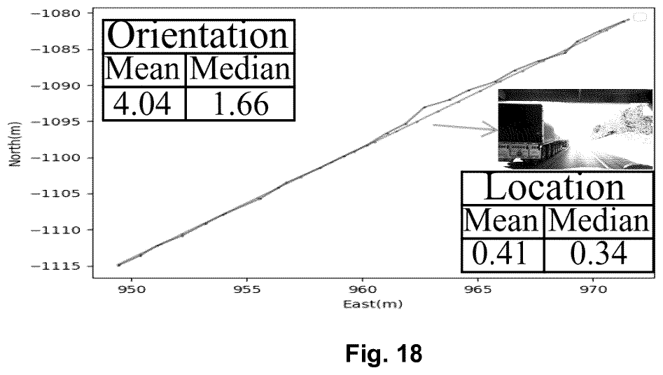

The resilience to temporal illumination changes of the current method was also assessed by conducting experiments on selected on-ground images that exhibit sudden illumination shifts, following the experimental setup as detailed herein above. In this regard, FIG. 18 shows the current method's robustness to these abrupt changes in illumination, with 1-camera using frames*87371406.png˜*89065099.png from “2017 Oct. 26-V2-Log 1” in the Ford Multi-AV dataset.

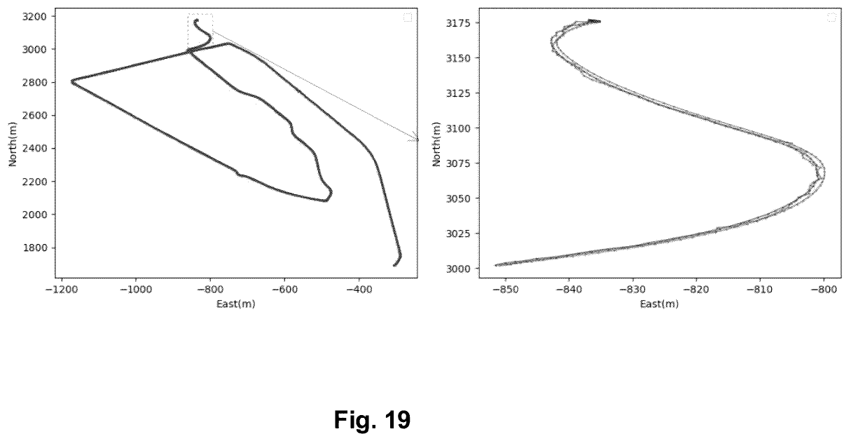

Furthermore, and although the current method does not process every frame in real-time, operating at an approximate speed of 4.5 FPS, it's important to note that by processing once every four frames (resulting in around 3.75 FPS), the current method still preserves its accuracy. As a post-processing pose refiner, the current method effectively refines poses and ensures route completion, as demonstrated in FIG. 19 that shows processing one frame every four frames (3.75 FPS) (green) yields results closely aligned with full-frame (blue) and ground truth (red) throughout the route, highlighting the current method's reliability and accuracy even with reduced frame processing.

### Ablation Study

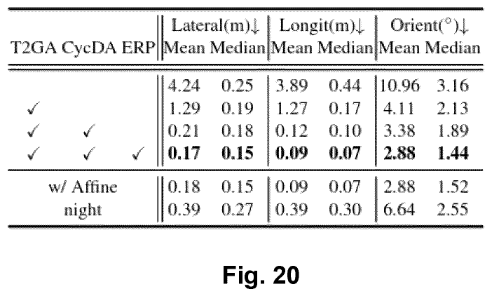

To evaluate the effectiveness of the current method, ablation studies were conducted in the ‘cross’ area of the KITTI CVL dataset. The current method's performance was compared across various configurations, including the presence and absence of CycDA and ERP loss functions and T2GA. The results, as shown in FIG. 20, underscore the role each component plays in improving the current method's performance.

In this regard, T2GA aggregates information from top to ground based on the assumption that the ground and satellite views are orthogonal. However, this assumption might not be accurate in scenarios involving uphill/downhill or turns. To test the current method's robustness under these conditions, affine warping was introduced to the ground view images with shear range of ±15°. The outcomes, labelled ‘w/Affine’ in FIG. 20, indicate the current method's efficacy in handling such scenarios. This is, in part, due to two factors: (1) the use of a U-Net for feature extraction allowing each pixel in the feature map to encapsulate information from its surrounding area, enabling the handling of a degree of angular variation, and (2) the satellite view from Google, which is not strictly orthogonal to the ground view, suggesting that the current method is adapted to these types of challenges.

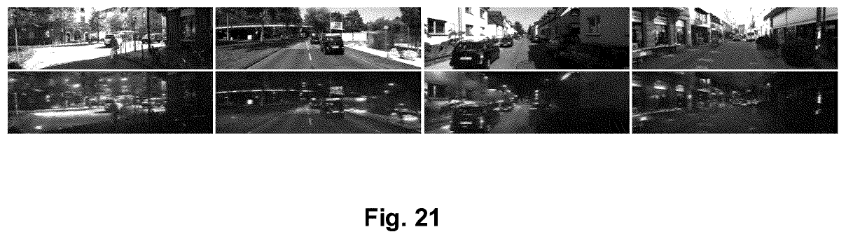

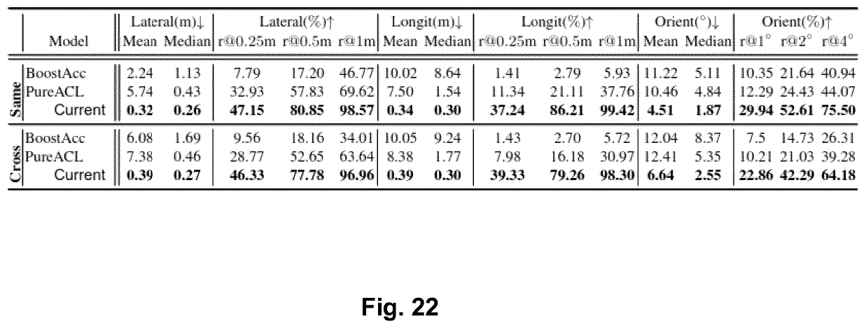

The current method was further evaluated on an artificial dataset derived from the KITTI test sets, created using the cross domain deep network proposed in Vinicius F Arruda, Thiago M Paixão, Rodrigo F Berriel, Alberto F De Souza, Claudine Badue, Nicu Sebe, and Thiago Oliveira-Santos, “Cross-domain car detection using unsupervised image-to-image translation: From day to night”, 2019 International Joint Conference on Neural Networks (IJCNN), pages 1-8. IEEE, 2019 (“[2]”), which transforms daytime scenes into their night time analogs. This transformation adjusts the images' lighting conditions and introduces nocturnal elements such as artificial lights and reduced visibility. FIG. 21 presents sample images in this regard. The outcomes, labeled as ‘night’ in FIG. 20 and FIG. 22, showing performance of the current method on KITTI Day-to-Night Dataset with initial noise (±45°, ±20 m), show the current method's stable performance in night time scenarios, highlighting its resilience to variations in lighting and time of day. Such robustness can be essential for real-world applications where lighting conditions can vary dramatically, proving the practicality and reliability of the current method in diverse operational environments.

Accordingly, the current method introduces a novel top-to-ground feature aggregation for enhancing cross-view image-based geo-localization. The current method overcomes limitations by incorporating aerial perspectives and utilizing a cycle domain adaptation loss for consistent feature extraction despite visual disparities. The introduction of the equidistant re-projection loss balances keypoint impact, promoting wider distribution and thus enhancing orientation accuracy. The current method therewith excels in vehicle pose estimation across challenging scenarios, achieving the lowest translation errors in KITTI and Ford datasets, and minimal orientation error with less accurate initial poses. By relying solely on the initial vehicle pose at the start, the current method can successfully complete routes via continuous pose estimation.

Throughout this specification and claims which follow, unless the context requires otherwise, the word “comprise”, and variations such as “comprises” or “comprising”, will be understood to imply the inclusion of a stated integer or group of integers or steps but not the exclusion of any other integer or group of integers. As used herein and unless otherwise stated, the term “approximately” means±20%.

Persons skilled in the art will appreciate that numerous variations and modifications will become apparent. All such variations and modifications which become apparent to persons skilled in the art, should be considered to fall within the spirit and scope that the invention broadly appearing before described.

1. A method for localising a ground-based query image captured by an imaging device with respect to an aerial image of a physical environment within which the imaging device is disposed, enabling a pose of the imaging device to be determined within the physical environment, the method including, in one or more processing devices:
obtaining query features identified in the ground-based query image;
identifying elevated features from the query features;
generating aggregated pixels by aggregating elevated pixels of the elevated features onto a ground plane of the ground-based query image; and
generating a query feature map using the aggregated pixels, wherein the query feature map is usable in localising the ground-based query image by mapping the query feature map to an aerial feature map of aerial features within the aerial image.

2. The method of claim 1, wherein the method includes in the one or more processing devices, for each elevated feature:
a. identifying corresponding ground pixels directly beneath the elevated pixels; and,
b. aggregating elevated and corresponding ground pixels.

3. The method of claim 1, wherein the method includes in the one or more processing devices, aggregating pixels of elevated features with the ground pixels using an attention mechanism.

4. The method of claim 3, wherein the method includes, in the one or more processing devices, generating by the attention mechanism, an attention feature map by:
a. determining a value and key from the elevated pixels;
b. generating a query using pixel data of the corresponding ground pixels;
c. applying a non-linear mapping to map the query and key to a common feature space;
d. computing a matrix product of the query and key; and,
e. generating a feature vector for the ground pixels using the matrix product and the value to generate the attention feature map including the feature vectors as the aggregated pixels.

5. The method of claim 4, wherein the method includes, in the one or more processing devices, vertically stacking the attention feature map with a ground plane query feature map to generate an aggregated feature map representing the query feature map.

6. The method of claim 1, wherein the method includes, in the one or more processing devices, mapping the query feature map to the aerial feature map by detecting query keypoints in the query feature map and mapping the query keypoints to matching aerial keypoints in the aerial feature map.

7. The method of claim 6, wherein in the one or more processing devices detecting the query keypoints and aerial keypoints includes:
a. generating a view-consistent confidence map representing a confidence of a feature appearing in both the query feature map and the aerial feature map;
b. generating a ground-plane confidence map representing a confidence of query features of the query feature map being on the ground-plane; and
c. detecting the query keypoints based on the view-consistent confidence map and the ground-plane confidence map.

8. The method of claim 6, wherein the method is performed, in the one or more processing devices, using at least one computational model.

9. The method of claim 8, wherein the at least one computational model has at least one parameter adjusted to adapt for a domain variation between the ground-based query image and the aerial image towards mapping the query feature map to the aerial feature map.

10. The method of claim 9, wherein the at least one parameter is adjusted to adapt for domain variation to account for a variance in focal length associated with the ground-based query image and the aerial image.

11. The method of claim 10, wherein the at least one computational model is trained to explicitly enforce view-invariant query and aerial feature maps based on L2 loss functions in three feature spaces to determine a query feature representation loss, an aerial feature representation loss and a latent feature representation loss.

12. The method of claim 11, wherein:
a. the query feature representation loss is based on an average of the squared difference between ground truth aerial keypoints of the aerial feature map, projected to and from a latent feature space guided by focal length, and matched query keypoints;
b. the aerial feature representation loss is based on an average of the squared difference between query keypoints, projected to and from the latent feature space guided by focal length, and matched ground truth aerial keypoints; and
c. the latent feature representation loss is based on an average of the squared difference between query keypoints, projected to the latent feature space guided by focal length, and ground truth aerial keypoints, projected to the latent feature space guided by focal length.

13. The method of claim 6, wherein the at least one computational model has at least one parameter adjusted to adapt for a perspective variation between the ground-based query image and the aerial image towards mapping the query feature map to the aerial feature map.

14. The method of claim 13, wherein the at least one parameter is adjusted to adapt for perspective variation to account for a variance between a mapped query keypoint and a matching ground truth aerial keypoint as a function of a distance between the matching ground truth aerial keypoint and a ground truth pose of the imaging device within the aerial feature map.

15. A system for localising a ground-based query image captured by an imaging device with respect to an aerial image of a physical environment within which the imaging device is disposed, enabling a pose of the imaging device to be determined within the physical environment, the system including one or more processing devices configured to:
obtain query features identified in the ground-based query image;
identify elevated features from the query features;
generate aggregated pixels by aggregating elevated pixels of elevated features onto a ground plane of the query image; and
generate a query feature map using the aggregated pixels, wherein the query feature map is usable in localising the ground-based query image by mapping the query feature map to an aerial feature map of aerial features within the aerial image.

16. A non-transitory computer-readable medium comprising computer-executable instructions that when executed perform the method of:
obtaining query features identified in the ground-based query image;
identifying elevated features from the query features;
generating aggregated pixels by aggregating elevated pixels of the elevated features onto a ground plane of the ground-based query image; and
generating a query feature map using the aggregated pixels, wherein the query feature map is usable in localising the ground-based query image by mapping the query feature map to an aerial feature map of aerial features within the aerial image.
